(19) United States
(12) Patent Application Publication
(10) Pub. No.: US 2016/0279720 A1
(43) Pub. Date: Sep. 29, 2016

(54) Optimized Superabrasive Cutting Elements and Methods for Designing and Manufacturing the Same

(71) Applicants: Craig Hodges Cooley, Saratoga Springs, UT (US); Jair Jahaziel Gonzalez, Provo, UT (US)

(72) Inventors: Craig Hodges Cooley, Saratoga Springs, UT (US); Jair Jahaziel Gonzalez, Provo, UT (US)

(73) Assignee: US Synthetic Corporation, Orem, UT (US)

(21) Appl. No.: 12/796,226

(22) Filed: Jun. 8, 2010

Related U.S. Application Data
(60) Provisional application No. 61/185,777, filed on Jun. 10, 2009.

(51) Int. Cl. E21B 10/36; B24D 3/04; B24D 18/00

(52) U.S. Cl. CPC B23D 18/0009; G06F 19/00

(57) ABSTRACT

A method of designing a cutting element optimized for cutting a particular formation type is disclosed. The method may include obtaining a measurement of at least one characteristic of a cutting element design at each of a plurality of leach depths. The method may also include determining an optimal leach depth for the cutting element design. The optimal leach depth may be a leach depth at which a magnitude of the at least one characteristic of the cutting element design is substantially optimal for cutting a selected formation type. A method of manufacturing a cutting element optimized for cutting a particular formation type is also disclosed.

### BACKGROUND

Wear-resistant, superabrasive materials are traditionally utilized for a variety of mechanical applications. For example, polycrystalline diamond (“PCD”) materials are often used in drilling tools (e.g., cutting elements, gage trimmers, etc.), machining equipment, bearing apparatuses, wire-drawing machinery, and in other mechanical systems.

Conventional superabrasive materials have found utility as superabrasive cutting elements in rotary drill bits, such as roller cone drill bits and fixed-cutter drill bits. A conventional cutting element may include a superabrasive layer or table, such as a PCD table. The cutting element may be brazed, press-fit, or otherwise secured into a preformed pocket, socket, or other receptacle formed in the rotary drill bit. In another configuration, the substrate may be brazed or otherwise joined to an attachment member such as a stud or a cylindrical backing. Generally, a rotary drill bit may include one or more PCD cutting elements affixed to a bit body of the rotary drill bit.

Cutting elements having a PCD table may be formed and bonded to a substrate using an ultra-high pressure, ultra-high temperature (“HPHT”) sintering process. Often, cutting elements having a PCD table are fabricated by placing a cemented carbide substrate, such as a cobalt-cemented tungsten carbide substrate, into a container or cartridge with a volume of diamond particles positioned on a surface of the cemented carbide substrate. A number of such cartridges may be loaded into a HPHT press. The substrates and diamond particle volumes may then be processed under HPHT conditions in the presence of a catalyst material that causes the diamond particles to bond to one another to form a diamond table having a matrix of bonded diamond crystals. The catalyst material is often a metal-solvent catalyst, such as cobalt, nickel, and/or iron, that facilitates intergrowth and bonding of the diamond crystals.

In one conventional approach, a constituent of the cemented-carbide substrate, such as cobalt from a cobalt-cemented tungsten carbide substrate, liquefies and sweeps from a region adjacent to the volume of diamond particles into interstitial regions between the diamond particles during the HPHT process. The cobalt may act as a catalyst to facilitate the formation of bonded diamond crystals. A metal-solvent catalyst may also be mixed with a volume of diamond particles prior to subjecting the diamond particles and substrate to the HPHT process.

The metal-solvent catalyst may dissolve carbon from the diamond particles and portions of the diamond particles that graphitize due to the high temperatures used in the HPHT process. The solubility of the stable diamond phase in the metal-solvent catalyst may be lower than that of the metastable graphite phase under HPHT conditions. As a result of the solubility difference, the graphite tends to dissolve into the metal-solvent catalyst and the diamond tends to deposit onto existing diamond particles to form diamond-to-diamond bonds. Accordingly, diamond grains may become mutually bonded to form a matrix of polycrystalline diamond, with interstitial regions defined between the bonded diamond grains being occupied by the metal-solvent catalyst. In addition to dissolving carbon and graphite, the metal-solvent catalyst may also carry tungsten, tungsten carbide, and/or other materials from the substrate into the PCD layer of the cutting element.

The presence of the solvent-metal catalyst and/or other materials in the diamond table may reduce the thermal stability of the diamond table at elevated temperatures. Accordingly, chemical leaching is often used to dissolve and remove various materials from the PCD layer. For example, chemical leaching may be used to remove metal-solvent catalysts, such as cobalt, from regions of a PCD layer that may experience high temperatures during drilling, such as regions adjacent to the working surfaces of the PCD layer. While leaching can increase the thermal stability of a PCD layer in high-temperature environments, leaching may also weaken the PCD layer, increasing the likelihood that the PCD layer will be damaged during drilling.

### SUMMARY

The instant disclosure is directed to exemplary methods of designing and manufacturing cutting elements optimized for cutting particular formation types, such as subterranean rock formation types. In some examples, a method may comprise obtaining a measurement of at least one characteristic of a cutting element design at each of a plurality of leach depths. The cutting element design may comprise a polycrystalline diamond table and the plurality of leach depths may comprise depths to which the polycrystalline diamond table is substantially depleted of interstitial material. In at least one example, the cutting element design may comprise a substrate and the polycrystalline diamond table may be bonded to the substrate. The interstitial material may comprise a metal-solvent catalyst (e.g., cobalt, nickel, iron, and/or an alloy thereof). The method may also comprise determining an optimal leach depth for the cutting element design. The optimal leach depth may comprise a leach depth at which a magnitude of the at least one characteristic of the cutting element design is substantially optimal for cutting a selected formation type.

In some embodiments, the method may comprise leaching a cutting element such that a polycrystalline diamond table of the cutting element is substantially depleted of interstitial material to the optimal leach depth. The at least one characteristic may comprise at least one of thermal stability, tensile strength, compressive strength, and/or shear strength. In various examples, the optimal leach depth may comprise a leach depth at which a balance of two or more of the at least one characteristic of the polycrystalline diamond table is substantially optimal for cutting the selected formation type. In some examples, the optimal leach depth may comprise a leach depth at which a balance of two or more of the at least one characteristic of the polycrystalline diamond table is substantially optimal for cutting a selected sequence of formation types. The method may also comprise determining the specific energy of rock removal for the selected formation type and/or sequence of formation types. In some examples, the method may comprise modeling the at least one characteristic of the cutting element design as a function of leach depth.

In some embodiments, a method of designing a cutting element may comprise modeling an initial residual stress state within a polycrystalline diamond volume of a cutting element design. The polycrystalline diamond volume of the cutting element design may comprise a first region including an interstitial material. In various examples, the method may comprise modeling a second residual stress state within the polycrystalline diamond volume of the cutting element design. At least a portion of the interstitial material may be depleted from the first region of the polycrystalline diamond volume.

In at least one example, the method may comprise determining an optimal residual stress state within the polycrystalline diamond volume of the cutting element design. The optimal residual stress state may be substantially optimal for cutting a selected formation type. In some examples, the method may comprise depleting at least a portion of an interstitial material from a polycrystalline diamond volume of a cutting element such that the cutting element substantially comprises the optimal residual stress state within the polycrystalline diamond volume.

In various examples, modeling at least one of the initial residual stress state and the second residual stress state within the polycrystalline diamond volume of the cutting element design may further include determining at least one of tensile stress, compressive stress, and/or shear stress within the polycrystalline diamond volume. In some embodiments, the method may comprise modeling an initial thermal stability and a second thermal stability of the polycrystalline diamond volume of the cutting element design. At least a portion of the interstitial material may be depleted from the first region of the polycrystalline diamond volume. In at least one example, the residual stress state within the polycrystalline diamond volume of the cutting element design may be modeled as a function of leach depth. A method of manufacturing a cutting element optimized for cutting a particular formation type is also disclosed.

Features from any of the described embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1A is a perspective view of an exemplary cutting element including a substrate and a superabrasive table according to at least one embodiment.

FIG. 1B is a cross-sectional side view of the exemplary cutting element illustrated in FIG. 1A.

FIG. 2 is a perspective view of an exemplary cutting element comprising a superabrasive table according to various embodiments.

FIG. 3 is a cross-sectional side view of a portion of the superabrasive table of the exemplary cutting elements illustrated in FIGS. 1A and 2.

FIG. 4 is a magnified cross-sectional side view of a portion of the superabrasive table illustrated in FIG. 3.

FIG. 5 is a perspective view of an exemplary drill bit according to at least one embodiment.

FIG. 6 is a graph illustrating thermal stability of an exemplary cutting element as a function of leach depth according to at least one embodiment.

FIG. 7 is a graph illustrating strength of an exemplary cutting element as a function of leach depth according to at least one embodiment.

FIG. 8 is a graph illustrating specific energy of rock removal as a function of depth of cut for an exemplary cutting element according to at least one embodiment.

FIG. 9 is a flow diagram of an exemplary method of designing a cutting element optimized for cutting a particular formation type according to at least one embodiment.

FIG. 10 is a flow diagram of an exemplary method of designing a cutting element according to additional embodiments.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The instant disclosure is directed to superabrasive cutting elements and drill bits used in drilling and/or other cutting operations. The cutting elements may be optimized for cutting selected formations. The optimized cutting elements may have optimal strength and thermal stability characteristics suited to selected formation types. The cutting elements disclosed herein may be used in a variety of applications, such as drilling tools, machining equipment, cutting tools, and other apparatuses, without limitation. The instant disclosure is also directed to methods for manufacturing superabrasive cutting elements optimized for cutting selected formations.

As used herein, the terms “superabrasive” and “superhard” refer to materials exhibiting a hardness exceeding a hardness of tungsten carbide. For example, a superabrasive article may represent an article of manufacture, at least a portion of which may exhibit a hardness exceeding the hardness of tungsten carbide. As used herein, the term “cutting” refers broadly to machining processes, drilling processes, boring processes, and/or any other material removal process utilizing a cutting element. As used herein, the term “strength” refers broadly to the ability of an article to resist the application of force. For example, the strength of a cutting element may refer to the ability of the cutting element to resist forces encountered during a drilling operation. Exposing an article to forces exceeding an article's strength may cause damage and/or wear to the article and/or may result in failure of the article. The compressive, tensile, and/or shear strength characteristics of an article may contribute to the article's overall strength.

As used herein, the phrase “specific energy” refers to the specific energy of removal, which may represent the work required to remove a volume or mass of material from a bulk material. For example, the specific energy of a geologic formation may refer to the work required to remove a volume of rock from the formation using a drill bit. Specific energy may be described in units of energy per unit of volume. As used herein, the phrase “depth of cut” refers to the cutting depth of a cutting article, such as a drill bit, cutting element, or other cutting implement, as the cutting article cuts into and/or removes material from a bulk material, such as a formation. The depth of cut may be measured as the difference in depth between a surface of the bulk material before and after being cut by the cutting article. In other words, the depth of cut may be measured as the thickness of the bulk material that is removed from the bulk material by the cutting article.

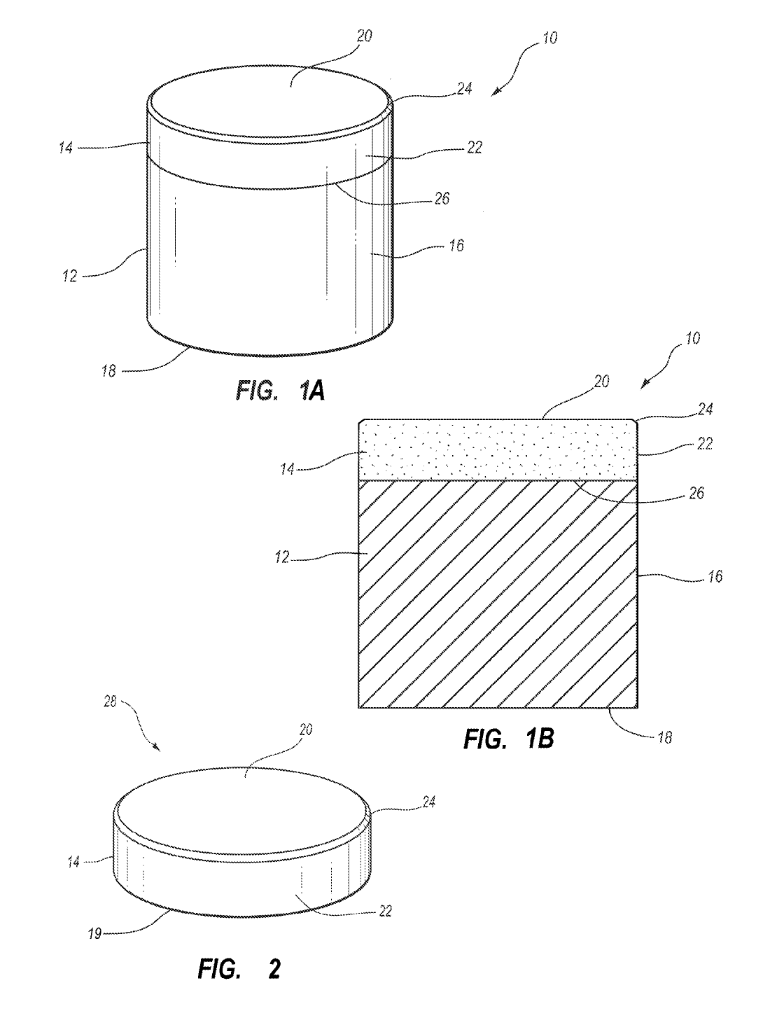

FIG. 1A is a perspective view of an exemplary cutting element 10 according to at least one embodiment. FIG. 1B is a cross-sectional side view of the exemplary cutting element 10 shown in FIG. 1A. As illustrated in FIGS. 1A and 1B, cutting element 10 may comprise a superabrasive table 14 affixed to or formed upon a substrate 12. Superabrasive table 14 may be affixed to substrate 12 at interface 26. Cutting element 10 may comprise a rear face 18 and a substrate side surface 16 formed by substrate 12. Cutting element 10 may also comprise a superabrasive face 20, a superabrasive side surface 22, and a superabrasive edge 24 formed by superabrasive table 14. Superabrasive edge 24 may comprise an angular or rounded edge formed at the intersection of superabrasive side surface 22 and superabrasive face 20. In additional embodiments, superabrasive edge 24 may comprise a chamfered surface or other selected geometry (e.g., radius, and/or chamfers, etc.) extending between superabrasive side surface 22 and superabrasive face 20. In various embodiments, superabrasive edge 24 may act as a cutting edge during drilling and/or cutting operations.

Substrate 12 may comprise any suitable material on which superabrasive table 14 may be formed. In at least one embodiment, substrate 12 may comprise a cemented carbide material, such as a cobalt-cemented tungsten carbide material, and/or any other suitable material. Further, substrate 12 may include a suitable metal-solvent catalyst material, such as, for example, cobalt, nickel, iron, and/or alloys thereof. Substrate 12 may also include any other suitable material including, without limitation, cemented carbides such as titanium carbide, niobium carbide, tantalum carbide, vanadium carbide, chromium carbide, and/or combinations of any of the preceding carbides cemented with iron, nickel, cobalt, and/or alloys thereof.

Superabrasive table 14 may be formed of any suitable superabrasive and/or superhard material or combination of materials, including, for example PCD. According to additional embodiments, superabrasive table 14 may comprise cubic boron nitride, silicon carbide, diamond, and/or mixtures or composites including one or more of the foregoing materials.

Superabrasive table 14 may be formed using any suitable technique. For example, superabrasive table 14 may comprise a PCD layer formed by subjecting a plurality of diamond particles (e.g., diamond particles having an average particle size between approximately 0.5 μm and approximately 150 μm) to a HPHT sintering process in the presence of a metal-solvent catalyst, such as cobalt, nickel, iron, and/or any other suitable group VIII element. During a HPHT sintering process, adjacent diamond crystals in a mass of diamond particles may become bonded to one another, forming a PCD table comprising bonded diamond crystals. In at least one example, bonded diamond crystals in superabrasive table 14 may have an average grain size of approximately 20 μm or less. Further, during a HPHT sintering process, diamond grains may become bonded to an adjacent substrate 12 at interface 26.

According to various embodiments, superabrasive table 14 may be formed by placing diamond particles adjacent to a substrate 12 comprising cemented tungsten carbide. The resulting sintered PCD layer may include various interstitial materials, including, for example, cobalt, tungsten, and/or tungsten carbide. For example, material components of substrate 12 may migrate into a mass of diamond particles used to form a superabrasive table 14 during HPHT sintering.

According to at least one embodiment, as the mass of diamond particles is sintered, a metal-solvent catalyst may melt and flow from substrate 12 into the mass of diamond particles. As the metal-solvent flows into superabrasive table 14, it may also dissolve and/or carry additional materials, such as tungsten and/or tungsten carbide, from substrate 12 into the mass of diamond particles. As the metal-solvent catalyst flows into the mass of diamond particles, the metal-solvent catalyst, and any dissolved and/or undissolved materials, may at least partially fill spaces between the diamond particles. The metal-solvent catalyst may facilitate bonding of adjacent diamond particles to form a PCD layer.

FIG. 2 is a perspective view of an exemplary cutting element 28, or cutting disc, according to at least one embodiment. As illustrated in FIG. 2, cutting element 28 may comprise a superabrasive table 14, or superabrasive disc, that is not attached to a substrate. Cutting element 28 may be formed using any suitable technique, including, for example, HPHT sintering, as described above. In some examples, cutting element 28 may be created by first forming a superabrasive element comprising a superabrasive layer bonded to a substrate, such as, for example, a cutting element 10 that includes a substrate 12 and a superabrasive table 14 (as illustrated in FIGS. 1A and 1B). Superabrasive table 14 may be separated from substrate 12 to form cutting element 28. Superabrasive table 14 may be separated from substrate 12 using a lapping process, a grinding process, a wire-electrical-discharge machining (“wire EDM”) process, or any other suitable material-removal process, without limitation. Cutting element 28 may comprise a rear face 19 that is formed by superabrasive table 14.

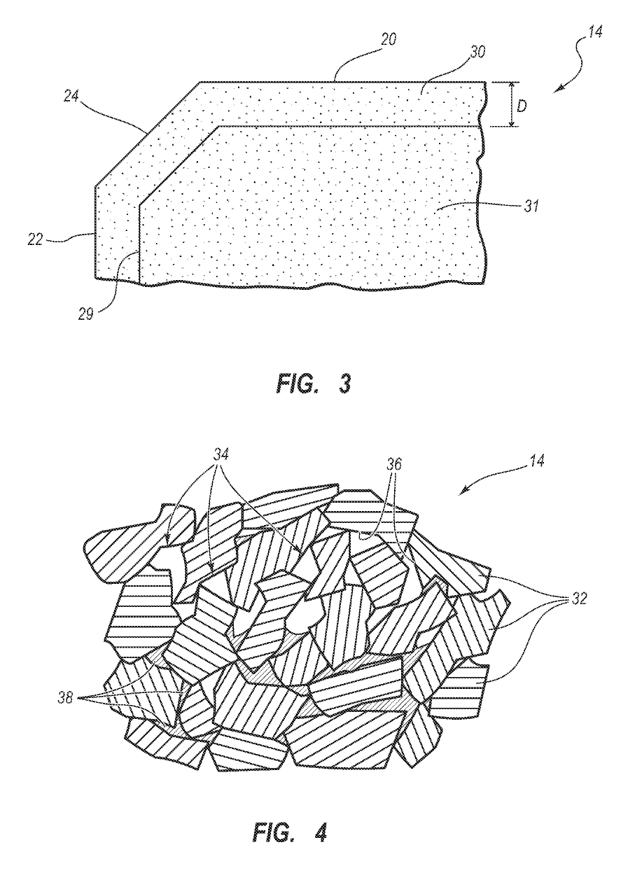

FIG. 3 is a cross-sectional side view of a portion of an exemplary superabrasive table 14, such as exemplary superabrasive tables 14 illustrated in FIGS. 1A and 2. Superabrasive table 14 may comprise a composite material, such as a PCD material. A PCD material may include a matrix of bonded diamond grains and interstitial regions defined between the bonded diamond grains. Such interstitial regions may be at least partially filled with various materials. In some embodiments, a metal-solvent catalyst may be disposed in interstitial regions in superabrasive table 14. Tungsten, tungsten carbide, and/or other materials may also be present in the interstitial regions.

Various residual stresses may remain within superabrasive table 14 following manufacturing of cutting element 10. For example, the HPHT sintering process used to form cutting element 10 may create residual stresses in a superabrasive layer 14 comprising PCD sintered with a metal-solvent catalyst. The residual stresses may be located in residual stress regions within superabrasive table 14. The residual stress regions may have varying magnitudes of residual stresses and may include compressive stresses, tensile stresses, and/or shear stresses.

Residual stresses may be developed in a PCD layer forming superabrasive table 14 due, at least in part, to differences in thermal expansion coefficients between polycrystalline diamond grains and a metal-solvent catalyst disposed between the grains. For example, during the HPHT sintering process, various materials, including the metal-solvent catalyst, may melt and flow between diamond particles forming superabrasive layer 14. The metal-solvent catalyst may adhere to surface portions of the diamond particles. Subsequently, as superabrasive layer 14 cools following the HPHT sintering process, the polycrystalline diamond grains may contract at a different rate than the metal-solvent catalyst. For example, the metal-solvent catalyst may contract more than the diamond grains for a given temperature reduction.

In some examples, residual stresses may also develop in superabrasive layer 14 due to thermal expansion differences between components of the PCD layer and substrate 12 to which the PCD layer becomes bonded during the HPHT sintering process. In various examples, residual stresses may also develop in superabrasive layer 14 due to various external forces or moments applied to superabrasive table 14 and/or substrate 12 during the manufacturing process.

The residual stresses may remain in superabrasive layer 14 after superabrasive layer 14 is cooled to a temperature below the solidification temperature of the metal-solvent catalyst. In some examples, the solidified metal-solvent catalyst may prevent at least some of the residual stresses in superabrasive layer 14 from being released. In at least one embodiment, after superabrasive layer 14 is cooled following HPHT sintering, superabrasive layer 14 may be held in a state of compressive stress by the metal-solvent catalyst. Residual stresses may affect the performance of a cutting element 10 or cutting element 28 comprising superabrasive layer 14.

In at least one example, compressive residual stresses, tensile residual stresses, and/or shear residual stresses developed within superabrasive layer 14 may improve the strength of the polycrystalline diamond during use. For example, compressive, tensile, and/or shear stresses within superabrasive layer 14 may inhibit fracture initiation and development, thereby preventing damage to superabrasive layer 14 (e.g., spalling, chipping, or delamination) during drilling. Superabrasive layer 14 of cutting element 10 may be exposed to various macroscopic and/or microscopic stresses during drilling. In some embodiments, macroscopic compressive stresses exerted on superabrasive layer 14 may cause at least a portion of superabrasive layer 14 to be exposed to tensile and/or shear stresses. For example, compressive stresses that superabrasive layer 14 may be exposed to on a macroscopic level may produce tensile and/or shear stresses within at least a portion of superabrasive layer 14 on a microscopic level.

Following sintering, various materials, such as a metal-solvent catalyst, remaining in interstitial regions within superabrasive table 14 may reduce the thermal stability of superabrasive table 14 at elevated temperatures. In some examples, the difference in thermal expansion coefficient between diamond grains in superabrasive table 14 and a metal-solvent catalyst in interstitial regions between the diamond grains may weaken portions of superabrasive layer 14 that are exposed to relatively high temperatures during drilling and/or cutting operations. The weakened portions of superabrasive layer 14 may be worn and/or damaged during the drilling and/or cutting operations.

In some embodiments, at relatively high temperatures, diamond grains in superabrasive layer 14 may undergo a chemical breakdown or back-conversion with the metal-solvent catalyst. At higher temperatures, portions of diamond grains may also be converted to carbon monoxide, carbon dioxide, graphite, or combinations thereof, thereby degrading the mechanical properties of a PCD material in superabrasive layer 14. In some embodiments, various forces, such as frictional forces, may produce significant heat at surface portions of superabrasive table 14 during cutting or drilling operations.

Removing the metal-solvent catalyst and/or other materials from superabrasive table 14 may improve the heat resistance and/or thermal stability of superabrasive table 14, particularly in situations where the PCD material may be exposed to high temperatures. The metal-solvent catalyst and/or other materials may be removed from superabrasive table 14 using any suitable technique, including, for example, leaching. In at least one embodiment, a metal-solvent catalyst, such as cobalt, may be removed from regions of superabrasive table 14 that may experience high temperatures, such as regions adjacent to the working surfaces of superabrasive table 14. Removing a metal-solvent catalyst from superabrasive table 14 may prevent weakening of the PCD material through expansion of the metal-catalyst. Additionally, removing a metal-solvent catalyst from superabrasive table 14 may decrease the heat conductivity of the PCD material from which the catalyst has been removed, inhibiting conduction of heat from a surface of superabrasive table 14 to an interior region of superabrasive table 14.

While removing the metal-solvent catalyst and/or other materials from superabrasive table 14 may improve the heat resistance and/or thermal stability of superabrasive table 14, removing the metal-solvent catalyst may also weaken portions of superabrasive table 14. In some examples, when a metal-solvent catalyst is removed from a portion of superabrasive table 14, residual stresses, such as compressive, tensile stresses, and/or shear stresses may also be released from at least this portion of superabrasive table 14. In at least one example, as a metal-solvent catalyst is removed from a portion of a PCD material forming superabrasive table 14, compressive, tensile stresses, and/or shear stresses within this portion of the PCD material may be removed, causing this portion of the PCD material to expand. Removing compressive stresses, tensile stresses, and/or shear stresses from superabrasive table 14 may weaken superabrasive table 14, making superabrasive table 14 susceptible to damage during drilling, particularly in drilling environments where the cutter is significantly loaded and/or stressed.

For example, reducing residual stresses within superabrasive layer 14, such as compressive, tensile, and/or shear stresses, may lead to a decrease in the overall strength of superabrasive layer 14 by decreasing the compressive strength, tensile strength, and/or shear strength of superabrasive layer 14. Superabrasive layer 14 may expand in accordance with the leach depth such that a deeper leach depth may cause portions of superabrasive layer 14 to expand to a greater extent. In one example, the deeper the leach depth in superabrasive layer 14, the lower the compressive, tensile, and/or shear strength remaining in superabrasive layer 14. According to some examples, a superabrasive layer 14 having a relatively shallow leach depth may remain in a substantially compressed and/or otherwise stressed state following leaching.

At least a portion of a metal-solvent catalyst, such as cobalt, as well as other materials, may be removed from at least a portion of superabrasive table 14 using any suitable technique, without limitation. For example, chemical leaching may be used to remove a metal-solvent catalyst from superabrasive table 14 up to a depth D from a surface of superabrasive table 14, as illustrated in FIG. 3. As shown in FIG. 3, depth D may be measured relative to an external surface of superabrasive table 14, such as superabrasive face 20, superabrasive side surface 22, and/or superabrasive edge 24. Any suitable leaching solution may be used to leach materials from superabrasive table 14, without limitation. In some embodiments, only portions of one or more surfaces of superabrasive table 14 may be leached, leaving remaining portions of the surfaces unleached. Other suitable techniques for removing a metal-solvent catalyst and/or other materials from superabrasive table 14 may include, for example, exposing the superabrasive material to electric current, microwave radiation, and/or ultrasonic, without limitation.

Following leaching, superabrasive table 14 may comprise a first volume 30 that is substantially free of a metal-solvent catalyst, as shown in FIG. 3. However, small amounts of catalyst may remain within interstices that are inaccessible to the leaching process. First volume 30 may extend from one or more surfaces of superabrasive table 14 (e.g., superabrasive face 20, superabrasive side surface 22, and/or superabrasive edge 24) to a depth D from the one or more surfaces. First volume 30 may be located adjacent one or more surfaces of superabrasive table 14.

Following leaching, superabrasive table 14 may also comprise a second volume 31 that contains a metal-solvent catalyst, as shown in FIG. 3. An amount of metal-solvent catalyst in second volume 31 may be substantially the same prior to and following leaching. In various embodiments, second volume 31 may be remote from one or more exposed surfaces of superabrasive table 14. In various embodiments, an amount of metal-solvent catalyst in first volume 30 and/or second volume 31 may vary at different depths in superabrasive table 14.

In at least one embodiment, superabrasive table 14 may include a transition region 29 between first volume 30 and second volume 31. Transition region 29 may include amounts of metal-solvent catalyst varying between an amount of metal-solvent catalyst in first volume 30 and an amount of metal-solvent catalyst in second volume 31. In various examples, transition region 29 may comprise a relatively narrow region between first volume 30 and second volume 31.

FIG. 4 is a magnified cross-sectional side view of a portion of the superabrasive table 14 illustrated in FIG. 3. As shown in FIG. 4, superabrasive table 14 may comprise grains 32 and interstitial regions 34 between grains 32 defined by grain surfaces 36. Grains 32 may comprise grains formed of any suitable superabrasive material, including, for example, diamond grains. At least some of grains 32 may be bonded to one or more adjacent grains 32, forming a polycrystalline diamond matrix.

Interstitial material 38 may be disposed in at least some of interstitial regions 34. Interstitial material 38 may comprise any suitable material, including, for example, a metal-solvent catalyst. As shown in FIG. 4, at least some of interstitial regions 34 may be substantially free of interstitial material 38. At least a portion of interstitial material 38 may be removed from at least some of interstitial regions 34 during a leaching procedure. For example, a substantial portion of interstitial material 38 may be removed from first volume 30 during a leaching procedure. Additionally, interstitial material 38 may remain in a second volume 31 following a leaching procedure.

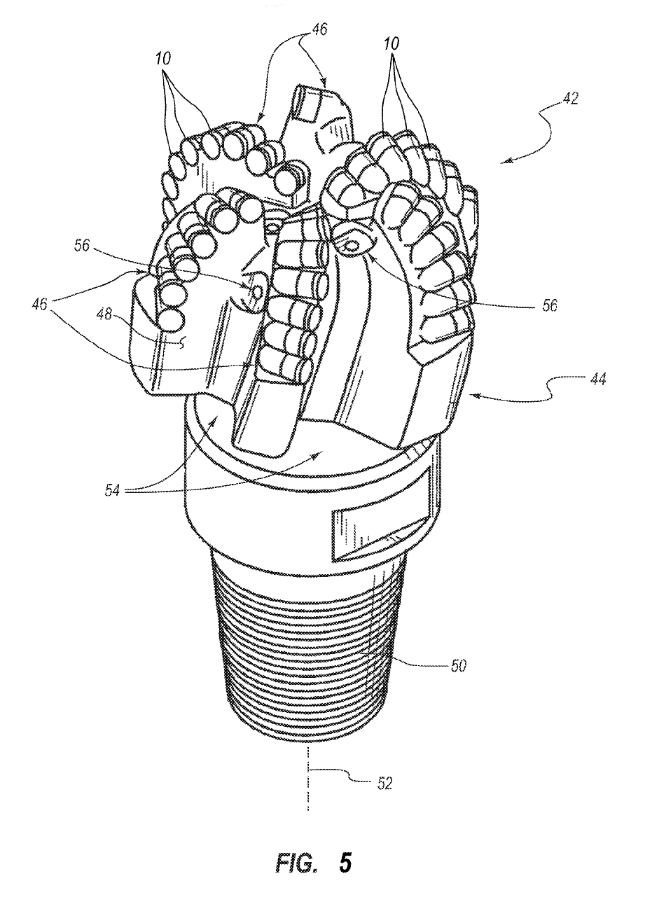

FIG. 5 is a perspective view of an exemplary drill bit 42 according to at least one embodiment. Drill bit 42 may represent any type or form of earth-boring or drilling tool, including, for example, a rotary drill bit. As illustrated in FIG. 5, drill bit 42 may comprise a bit body 44 having a longitudinal axis 52. Bit body 44 may define a leading end structure for drilling into a subterranean formation by rotating bit body 44 about longitudinal axis 52 and applying weight to bit body 44. Bit body 44 may include radially and longitudinally extending blades 46 with leading faces 48 and a threaded pin connection 50 for connecting bit body 44 to a drill string.

At least one cutting element 10 may be coupled to bit body 44. For example, as shown in FIG. 5, a plurality of cutting elements 10 may be coupled to blades 46. Cutting elements 10 may comprise any suitable superabrasive cutting elements, without limitation. For example, each cutting element 10 may include a superabrasive table 14, such as a PCD table, bonded to a substrate 12 (as illustrated in FIG. 1A). In some embodiments, cutting elements 28 (as illustrated in FIG. 2) may be used in place of one or more cutting elements 10. Circumferentially adjacent blades 46 may define so-called junk slots 54 therebetween. Junk slots 54 may be configured to channel debris, such as rock or formation cuttings, away from cutting elements 58 during drilling. Rotary drill bit 42 may also include a plurality of nozzle cavities 56 for communicating drilling fluid from the interior of rotary drill bit 42 to cutting elements 10.

FIG. 5 depicts an example of a rotary drill bit 42 that employs at least one cutting element 10 comprising a superabrasive table 14 fabricated and structured in accordance with the disclosed embodiments, without limitation. Rotary drill bit 42 may additionally represent any number of earth-boring or drilling tools, including, for example, core bits, roller-cone bits, fixed-cutter bits, eccentric bits, bicenter bits, reamers, reamer wings, or any other downhole tool including superabrasive cutting elements and discs, without limitation.

Cutting elements 10 and/or cutting elements 28, as disclosed herein, may be employed in any suitable article of manufacture that includes a superabrasive element, disc, or layer. Other examples of articles of manufacture that may incorporate superabrasive cutting elements and/or other superabrasive elements as disclosed herein may be found in U.S. Pat. Nos. 4,811,801; 4,268,276; 4,468,138; 4,738,322; 4,913,247; 5,016,718; 5,092,687; 5,120,327; 5,135,061; 5,154,245; 5,460,233; 5,544,713; and 6,793,681, the disclosure of each of which is incorporated herein, in its entirety, by this reference.

A drill bit including cutting elements 10 and/or cutting elements 28, such as drill bit 42, may be used for drilling in various environments. For example, drill bit 42 may be utilized in drilling different types of formations having different compositions. In some embodiments, drill bit 42 may encounter a plurality of different types of geologic formations while drilling a single borehole. For example, drill bit 42 may drill through a relatively weak formation higher up a borehole. As the borehole is drilled to a lower depth, drill bit 42 may encounter formations that are stronger, requiring additional energy output to remove portions of the formation.

Cutting elements 10 and/or cutting elements 28 may be optimized for drilling particular formation types. For example, different cutting elements 10 and/or cutting elements 28 may be used for drilling different formations, such that the cutting elements 10 and/or cutting elements 28 are optimized for the particular type of formation being drilled by drill bit 42. According to at least one example, a superabrasive table 14 of a cutting element 10 and/or cutting element 28 may be optimized by removing a metal-solvent catalyst, and/or any other suitable material, from superabrasive table 14 to an optimal depth or range of depths suitable for drilling a particular formation type. The metal-solvent catalyst, and/or other suitable materials, may be removed from superabrasive table 14 using any suitable technique, such as, for example, leaching.

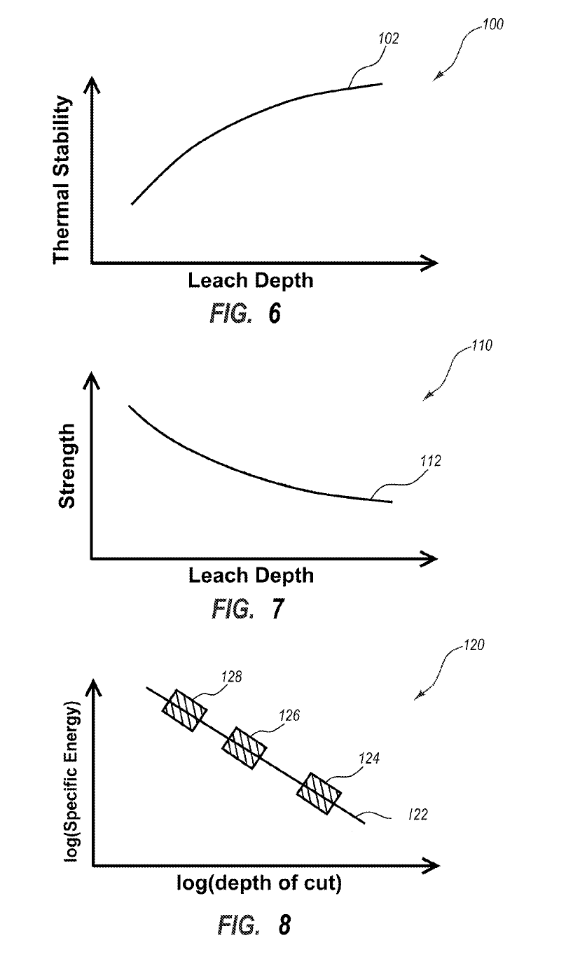

FIGS. 6 and 7 show graphs illustrating various characteristics of an exemplary cutting element (such as cutting elements 10 and 28 in FIGS. 1A-2) as a function of leach depth of a superabrasive table (such as superabrasive table 14 in FIGS. 1A-2) according to at least one embodiment. In some embodiments, the relationship between the leach depth of superabrasive tables of various cutting element designs and the strength, heat resistance, and/or any other characteristics of the superabrasive tables may be determined by leaching superabrasive tables to various depths and measuring characteristics of the superabrasive tables. In at least one example, relationships between amounts of interstitial material removed from the superabrasive tables and one or more resulting characteristics of the superabrasive tables may be analyzed and modeled using various modeling techniques, including, for example, interpolation and/or statistical regression techniques. For example, leach depths providing desired characteristics in a superabrasive table may be determined or predicted using interpolation, statistical regression, and/or other suitable analyses based on known data points.

In some embodiments, residual stress states within a superabrasive table of a cutting element design may be modeled at various leach depths. For example, the residual stress state within the polycrystalline diamond volume of the cutting element design may be modeled as a function of leach depth. The residual stress states may describe compressive, tensile, and/or shear stresses within at least a portion of the superabrasive table. The thermal stability of the superabrasive table may also be modeled at various leach depths. In at least one example, an initial residual stress state and/or initial thermal stability of a polycrystalline diamond volume of a superabrasive table may be modeled. The polycrystalline diamond volume may include a first region including an interstitial material. In some examples, the initial residual stress state and/or initial thermal stability of the polycrystalline diamond volume may be determined for a superabrasive table prior to leaching.

In various embodiments, one or more additional residual stress states within the superabrasive table of the cutting element design may be modeled after various amounts of the interstitial material have been removed from the polycrystalline diamond volume. For example, at least a portion of the interstitial material may be depleted from the polycrystalline diamond volume using any suitable technique, including, for example, leaching. Following depletion of at least a portion of the interstitial material from the polycrystalline diamond volume, a second residual stress state of the polycrystalline diamond volume may be modeled.

As illustrated by graph 100 in FIG. 6, the thermal stability of a superabrasive layer of a particular cutting element design may increase as the leach depth of a superabrasive table is increased. In this example, line 102 represents the thermal stability of a superabrasive table 14 (as illustrated in FIGS. 1A-2) leached to different leach depths. As illustrated by line 102, changes in the leach depth may have a more significant effect on the thermal stability of superabrasive table 14 when the leach depth is relatively shallow. At deeper leach depths, changes in the leach depth may have less of an impact on the thermal stability of superabrasive table 14. Any suitable techniques may be used to measure thermal stability characteristics of cutting elements, without limitation. For example, a mill test may be used to directly measure the thermal stability of superabrasive table 14.

As illustrated by graph 110 in FIG. 7, the strength of a superabrasive layer of a particular cutting element design may decrease as the leach depth of the superabrasive layer is increased. In this example, line 112 represents the strength of superabrasive table 14 at different leach depths. The strength of superabrasive table 14 illustrated in FIG. 7 may include the compressive, tensile, and/or shear strength of superabrasive table 14. As illustrated by line 112, changes in the leach depth may have a more significant effect on the strength of superabrasive table 14 when the leach depth is relatively shallow. At deeper leach depths, changes in the leach depth may have less of an impact on the strength of superabrasive table 14.

As discussed above, residual stresses within superabrasive layer 14, including compressive, tensile, and/or shear stresses, may contribute to the compressive strength, tensile strength, and/or shear strength of superabrasive layer 14. Cutting elements having different residual stress states may exhibit different overall strength characteristics due to differences in the compressive, tensile, and/or shear strength within superabrasive layer 14. Any suitable techniques may be used to measure one or more strength characteristics of cutting elements, without limitation. For example, a burst disk test may be used to directly measure the tensile strength of superabrasive table 14 of a cutting element.

In additional examples, a slow sliding velocity wet abrasion test may be used to measure the compressive strength of superabrasive table 14. In some examples, during the slow sliding velocity wet abrasion test, superabrasive table 14 may be placed in direct contact with a test material. Superabrasive table 14 may be moved and/or rotated relative to a test material that a cutting edge of superabrasive table 14 (e.g., superabrasive edge 24 in FIGS. 1A-2) directly contacts while under compression. The number of cutting passes of superabrasive table 14 required for the cutting edge to break down may be used as a measure of the fatigue life and/or compressive strength of superabrasive table 14.

Modeling various characteristic of cutting elements, such as residual stresses, strength, thermal stability, and/or or leach depth characteristic of superabrasive table 14, may facilitate the efficient and accurate design of cutting elements that are substantially optimized for cutting selected formation types and/or selected sequences of formation types. Based on the relationships between residual stresses, strength, thermal stability, and/or leach depth of superabrasive table 14 as illustrated in FIGS. 6 and 7, a particular leach depth or range of leach depths that are optimal for drilling particular formations may be determined. Thus, cutting element 10 and/or cutting element 28 in FIGS. 1A-2 comprising a superabrasive table 14 leached to a depth that is optimal for cutting a particular formation type may be better suited to drilling a selected formation type and/or sequence of formation types than conventional cutting elements.

For example, a superabrasive table (such as superabrasive table 14 in FIGS. 1A-2) that is leached to a depth that is optimal for drilling a particular formation type may have a balance of strength and thermal stability that is optimal for cutting the particular formation type. Thus, cutting element 10 and/or cutting element 28 comprising a superabrasive table 14 having an optimal balance of strength and thermal stability for cutting a particular formation type may be more resistant to damage (e.g., spalling, chipping, or delamination) during drilling of a selected formation and/or sequence of formation types, thereby extending the life of the cutting element. In addition to extending the life of the cutting element, inhibiting damage to superabrasive table 14 during drilling may also protect and maintain the cutting effectiveness of cutting edges of superabrasive table 14, such as superabrasive edge 24 (as illustrated in FIGS. 1A and 1B), thereby maximizing the useful life of the cutting element.

An optimal balance of strength and thermal stability for a cutting element 10 and/or cutting element 28 may be correlated to characteristics of the formation type and/or sequence of formation types to be cut by the cutting element. For example, drilling a relatively hard formation that is relatively difficult to cut may generate a significant amount of frictional heat at cutting edges and/or surface portions of superabrasive table 14. Accordingly, a superabrasive table 14 that is optimized for cutting a relatively hard formation may have a relatively higher thermal stability. In various examples, a superabrasive table 14 that is optimized for cutting a varied formation that is relatively easier to cut may not have such a high thermal stability. However, such a superabrasive table 14 may have a relatively higher strength to resist damage due to significant loading and stresses encountered by superabrasive table 14 during drilling of a varied formation.

The difficulty or ease of drilling a formation may be quantified by the work required to remove a volume or mass of material, such as a volume of rock, from a formation. In various examples, the work required to remove a volume of rock may be described by specific energy in units of energy per unit of volume. In at least one example, the higher the specific energy of a formation, the greater the amount of heat generated at the surface of a cutting element, such as a surface of superabrasive table 14, as the formation is drilled by the cutting element. The specific energy of a material, such as a formation, may be correlated to one or more characteristics of the material. For example, the specific energy of a formation may be described as a function of characteristic length, such as the depth of cut of cutting element 10 and/or cutting element 28 into the formation during drilling. In at least one example, when cutting element 10 and/or cutting element 28 is moved at a substantially constant rate under a substantially constant force while cutting a formation, the specific energy of the formation may be correlated to the depth of cut.

According to at least one embodiment, the specific energy of various formation types may also be at least partially correlated to additional variables, such as, for example, data variables obtained during drilling of formations (e.g., data obtained during drilling of wells, etc.). In some examples, the specific energy of a portion of a formation may be correlated to the depth at which the portion of the formation is buried. For example, rock formations may comprise frictional rock materials that are strengthened and hardened by confining pressures. The confining pressures exerted on rock materials in a formation may increase in conjunction with increases in the depth at which the rock materials are buried. Rock materials that are more deeply buried may experience relatively higher confining pressures and may have relatively higher specific energies of removal. Accordingly, the deeper a portion of a formation is buried, the higher the specific energy that may be required to excavate the portion of the formation during drilling.

FIG. 8 shows a graph 120 illustrating specific energy as a function of depth of cut for an exemplary cutting element, such as a cutting element 10 and/or a cutting element 28 in FIGS. 1A-2, according to at least one embodiment. As illustrated by graph 120, the specific energy of various formation types may be correlated to a depth of cut made in the various formation types by the exemplary cutting element under substantially constant drilling and/or cutting conditions (e.g., rate of rotation, weight on bit, etc.). In at least one embodiment, the relationship between the specific energy of the formation types and depth of cut may be described as a substantially linear relationship between log(specific energy) and log(depth of cut), as shown by graph 120. In this example, line 122 represents a log(specific energy) and a log(depth of cut) for the exemplary cutting element. The correlation shown by line 122 may be used to determine a particular specific energy for a formation type based on a depth of cut made in the formation type by a cutting element.

Locations 124, 126, and 128 along line 122 may represent a specific energy, or range of specific energies, for various types of rock formations. In various embodiments, cutting elements, such as cutting elements 10 and/or cutting elements 28, may be optimized for drilling any suitable formation type (such as formation types represented by locations 124, 126, and 128 in FIG. 8) by leaching a superabrasive table 14 of the cutting elements to leach depths that provide superabrasive table 14 with an optimal amount and/or balance of strength and/or thermal stability for drilling the formation types.

Correlations between the leach depth of superabrasive table 14 and the strength (e.g., compressive, tensile, and/or shear strength), heat resistance, residual stress state (including compressive, tensile, and/or shear stresses), and/or any other characteristic of superabrasive table 14 may be used to determine an optimal leach depth for particular formation types. A cutting element comprising a superabrasive table 14 that is leached to a leach depth that is optimal for drilling a particular formation type may be subject to a substantially minimal amount of damage and/or wear during drilling of the particular formation type. Accordingly, such a cutting element may have a substantially maximal useable life and may maintain its effectiveness for a substantially maximal length of time when used to drill the particular formation type.

In at least one embodiment, location 124 in graph 120 may represent specific energies of various rock formation types that are relatively easy to drill, such as, for example, weak sandstone, weak limestone, shale formations, and/or formations located relatively higher in a borehole that are not subjected to relatively large effective confining stresses. As shown by graph 120, such weaker formations having relatively low specific energies, as represented by location 124, may require a relatively low amount of work per volume of material removed and may be cut to relatively deeper depths of cut by a cutting element.

Because of the lower specific energy of such weaker formations, a relatively low amount of heat may be generated at the surface of a cutting element during drilling. As such, a superabrasive table of a cutting element used to cut such formations may not require a high thermal stability or a high strength to inhibit damage to the superabrasive table during drilling. In at least one example, a cutting element optimized for cutting such relatively weaker formations may comprise a superabrasive table (such as superabrasive table 14 in FIGS. 1A-2) leached to a relatively shallow leach depth to provide a relatively stronger superabrasive table having a slower wear rate, and accordingly, a longer operating life.

In various embodiments, location 126 in graph 120 in FIG. 8 may represent specific energies of rock formation types having a relatively low to moderate hardness, such as, for example, sandstone and/or hard carbonate formations. In some examples, such formations may include varied formations, such as sandstone formations having hard nodules, such as hard carbonate nodules. Such varied formations may be more difficult to drill than rock formations having specific energies represented by location 124. In at least one example, varied formations having specific energies represented by location 126 may be located at a mid-borehole horizon and may be subjected to relatively moderate effective confining stresses. As shown by graph 120, formations having relatively moderate specific energies, as represented by location 126, may require a relatively moderate amount of work per volume of material removed and may be cut to relatively moderate depths of cut by a cutting element.

In some examples, varied formations, such as formations comprising sandstone with hard nodules, may subject a cutting element to significant loading and/or stress during drilling, even though the specific energy of the formation may be relatively moderate. A superabrasive table (such as superabrasive table 14 in FIGS. 1A-2) of a cutting element optimized to cut such formations may be relatively strong to prevent wear and/or damage as the superabrasive table is loaded and stressed during drilling. However, because the specific energy of the varied formation is relatively moderate, superabrasive layer 14 may not require a high thermal stability to prevent wear and/or damage to superabrasive table 14 due to frictional heat generation. Accordingly, a cutting element optimized for cutting such varied formations may comprise a superabrasive table 14 that is leached to a relatively moderate depth to provide a relatively stronger superabrasive table 14 having a relatively moderate thermal stability.

In at least one embodiment, location 128 in graph 120 in FIG. 8 may represent specific energies of rock formation types that are relatively difficult to drill, such as, for example, granite, gneiss, strong limestone, strong dolomite, various hard crystalline rock formations, and/or various formation types that are subjected to a relatively large effective confining stresses. As shown by graph 120, such harder formations having relatively high specific energies, as represented by location 128, may require a relatively high amount of work per volume of material removed and may be cut to relatively shallow depths of cut by a cutting element. As such, as harder formations are cut by a cutting element, a significant amount of frictional heat may be generated at surface portions of the cutting element, such as cutting surfaces and/or cutting edges of superabrasive table 14 in FIGS. 1A-2. Accordingly, a superabrasive table of a cutting element optimized for cutting harder formations may have a relatively high thermal stability to inhibit damage to the superabrasive table during drilling.

In some examples, harder formations having specific energies represented by location 128 in FIG. 8 may be generally homogenous in composition and/or hardness. Such harder, homogenous formations may include, for example, strong homogenous limestone and/or strong homogenous dolomite. A cutting element used for drilling formations that are generally homogenous in composition and/or hardness may not be subject to significant adverse stresses during drilling. Accordingly, in at least one example, a superabrasive table (such as superabrasive table 14 in FIGS. 1A-2) of a cutting element optimized for cutting such harder, homogenous formations may not be required to have a high amount of strength to inhibit damage to superabrasive table 14 during drilling. In at least one embodiment, a cutting element optimized for cutting such harder, homogenous formations may be leached to a relatively deeper depth to provide superabrasive table 14 having a relatively high thermal stability.

In certain examples, deeply buried formations may comprise harder rock material that is not homogenous in composition and/or hardness. Thermal stability and strength may both be important characteristics of a superabrasive table of a cutting element optimized for cutting such harder, heterogenous formations. In at least one example, thermal stability of the superabrasive table may be more important than absolute strength for drilling harder, heterogenous formations. Accordingly, a cutting element optimized for cutting harder, heterogenous formations may be leached to a relatively deeper depth that provides superabrasive table 14 with a relatively high thermal stability while maintaining adequate strength.

In some embodiments, different cutting elements (such as cutting element 10 and/or cutting element 28 in FIGS. 1A-2) may be used for drilling a borehole through a plurality of different types of formations. The different cutting elements 10 and/or cutting elements 28 may comprise superabrasive tables 14 having different leach depths optimized for each of the plurality of different types of formations. In at least one example, a first drill bit may comprise cutting elements optimized for cutting a first formation type. The cutting elements may comprise superabrasive tables 14 that are leached to depths that are optimal for drilling the first formation type. The first drill bit may be used to drill a portion of a borehole extending through a first formation. Similarly, a second drill bit comprising cutting elements optimized for cutting a second formation type may then be used to drill a portion of the borehole extending through a second formation.

Cutting elements may be modeled using various techniques to analyze the characteristics and/or performance of the cutting elements when interstitial materials have been depleted from superabrasive tables 14 of the cutting elements to various extents. In at least one embodiment, simulation techniques, such as finite element analysis (“FEA”), may be used to analyze characteristics of partially leached and/or non-leached cutting elements under various conditions. In some examples, FEA may be used to determine the magnitude and/or effect of compressive stresses, tensile stresses, shear stresses, and/or heat within various portions of cutting elements during drilling operations and/or test procedures. FEA results may be used to determine optimal leach depths for superabrasive tables 14 of cutting element designs.

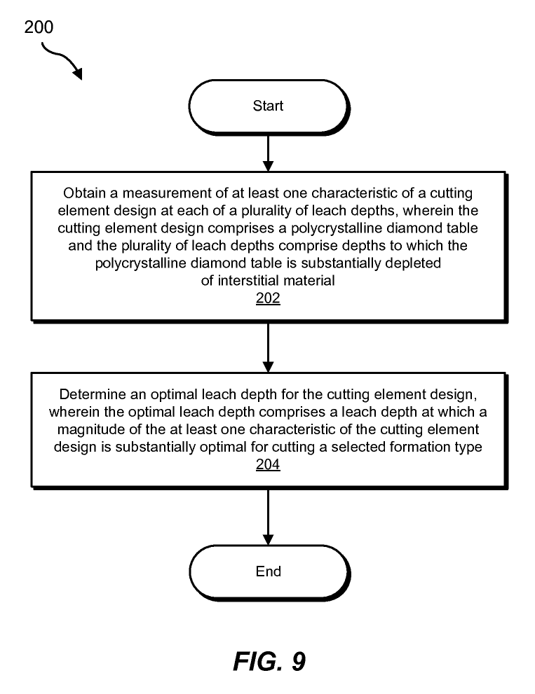

FIG. 9 illustrates an exemplary method 200 of designing a cutting element optimized for cutting a particular formation type according to at least one embodiment. As shown in FIG. 9, a measurement of at least one characteristic of a cutting element design may be obtained at each of a plurality of leach depths (process 202). The cutting element design may comprise a polycrystalline diamond table. In some examples, the polycrystalline diamond table may be bonded to a suitable substrate, such as, for example, a tungsten carbide substrate. One or more cutting elements may be used in measuring the at least one characteristic of the cutting element design. In some embodiments, at least one residual stress state within the polycrystalline diamond table of the cutting element design may be modeled using the measurement of the at least one characteristic of the cutting element design.

The plurality of leach depths may comprise depths to which the polycrystalline diamond table is substantially depleted of interstitial material. The interstitial material may comprise one or more compounds, including, for example, a metal-solvent catalyst such as cobalt, nickel, iron, and/or an alloy thereof. The interstitial material may be depleted from the polycrystalline diamond table to the leach depths using any suitable technique, without limitation. For example, the interstitial material may be depleted from the polycrystalline diamond table to a selected leach depth by exposing the polycrystalline diamond table to a suitable leaching solution for a suitable length of time.

An optimal leach depth for the cutting element design may then be determined (process 204). The optimal leach depth may comprise a leach depth at which a magnitude of the at least one characteristic of the cutting element design is substantially optimal for cutting a selected formation type. In some examples, the optimal leach depth may comprise a leach depth at which a magnitude of the at least one characteristic of the cutting element design is substantially optimal for cutting a selected sequence of formation types. The at least one characteristic of the cutting element design may include at least one of thermal stability, tensile strength, compressive strength, and/or shear strength.

In various examples, the optimal leach depth may comprise a leach depth at which a balance of two or more of the at least one characteristic of the polycrystalline diamond table is substantially optimal for cutting the selected formation type and/or sequence of formation types. In at least one example, the at least one characteristic of the cutting element design may be modeled as a function of leach depth. The specific energy of rock removal for the selected formation type may also be determined. In some embodiments, a cutting element may be leached such that a polycrystalline diamond table of the cutting element is substantially depleted of interstitial material to the optimal leach depth. The cutting element may be manufactured such that it is substantially identical to the cutting element design.

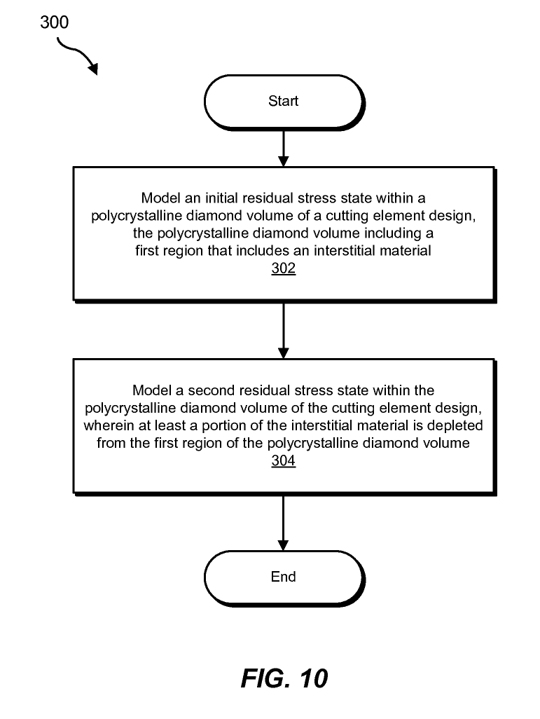

FIG. 10 illustrates an exemplary method 300 of designing a cutting element according to various embodiments. As shown in FIG. 10, an initial residual stress state within a polycrystalline diamond volume of a cutting element design may be modeled (process 302). The polycrystalline diamond volume of the cutting element design may include a first region that includes an interstitial material. Modeling the initial residual stress state within the polycrystalline diamond volume of the cutting element design may include measuring at least one of tensile stress, compressive stress, and/or shear stress within the polycrystalline diamond volume.

A second residual stress state within the polycrystalline diamond volume of the cutting element design may be modeled (process 304). At least a portion of the interstitial material may be depleted from the first region of the polycrystalline diamond volume. The interstitial material may be depleted from the polycrystalline diamond material using any suitable technique, such as, for example, leaching. Modeling the second residual stress state within the polycrystalline diamond volume of the cutting element design may include determining at least one of tensile stress, compressive stress, and/or shear stresses within the polycrystalline diamond volume. In some embodiments, additional residual stress states may be modeled after the polycrystalline diamond volume of the cutting element design has been depleted of interstitial material to various extents. For example, the residual stress state of the polycrystalline diamond volume of the cutting element design may be modeled at each of a plurality of leach depths.

In various embodiments, at least one of the initial residual stress state and the second residual stress state of the polycrystalline diamond volume of the cutting element design may be determined by obtaining a measurement of at least one characteristic of the cutting element design. The at least one characteristic may comprise at least one of, thermal stability, tensile strength, compressive strength, and/or shear strength, without limitation. In at least one example, the residual stress state within the polycrystalline diamond volume of the cutting element design may be modeled as a function of leach depth

In some examples, an optimal residual stress state within the polycrystalline diamond volume of the cutting element design may be determined. The optimal residual stress state may be substantially optimal for cutting a selected formation type and/or sequence of formation types. In some examples, at least a portion of an interstitial material may be depleted from a polycrystalline diamond volume of a cutting element such that the cutting element substantially comprises the optimal residual stress state within the polycrystalline diamond volume.

In various embodiments, an initial thermal stability of the polycrystalline diamond volume of the cutting element design may be modeled. A second thermal stability of the polycrystalline diamond volume of the cutting element design may also be modeled. At least a portion of the interstitial material may be depleted from the first region of the polycrystalline diamond volume.

The preceding description has been provided to enable others skilled in the art to best utilize various aspects of the exemplary embodiments described herein. This exemplary description is not intended to be exhaustive or to be limited to any precise form disclosed. Many modifications and variations are possible without departing from the spirit and scope of the instant disclosure. It is desired that the embodiments described herein be considered in all respects illustrative and not restrictive and that reference be made to the appended claims and their equivalents for determining the scope of the instant disclosure.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”

1. A method of designing a cutting element optimized for cutting a particular formation type, the method comprising:
obtaining a measurement of at least one characteristic of a cutting element design at each of a plurality of leach depths, wherein the cutting element design comprises a polycrystalline diamond table and the plurality of leach depths comprise depths to which the polycrystalline diamond table is substantially depleted of interstitial material;
determining an optimal leach depth for the cutting element design, wherein the optimal leach depth comprises a leach depth at which a magnitude of the at least one characteristic of the cutting element design is substantially optimal for cutting a selected formation type.

2. The method of claim 1, further comprising leaching a cutting element such that a polycrystalline diamond table of the cutting element is substantially depleted of interstitial material to the optimal leach depth.

3. The method of claim 1, wherein the at least one characteristic comprises at least one of:
thermal stability;
tensile strength;
compressive strength;
shear strength.

4. The method of claim 3, wherein the optimal leach depth comprises a leach depth at which a balance of two or more of the at least one characteristic of the polycrystalline diamond table is substantially optimal for cutting the selected formation type.

5. The method of claim 4, further comprising determining the specific energy of rock removal for the selected formation type.

6. The method of claim 3, wherein the optimal leach depth comprises a leach depth at which a balance of two or more of the at least one characteristic of the polycrystalline diamond table is substantially optimal for cutting a selected sequence of formation types.

7. The method of claim 1, wherein the interstitial material comprises a metal-solvent catalyst.

8. The method of claim 7, wherein the metal-solvent catalyst comprises at least one of cobalt, nickel, and iron.

9. The method of claim 1, further comprising modeling at least one residual stress state within the polycrystalline diamond table of the cutting element design using the measurement of the at least one characteristic of the cutting element design.

10. The method of claim 1, further comprising modeling the at least one characteristic of the cutting element design as a function of leach depth.

11. A method of designing a cutting element, the method comprising:
modeling an initial residual stress state within a polycrystalline diamond volume of a cutting element, wherein the polycrystalline diamond volume is bonded to a substrate, the polycrystalline diamond volume further comprising an interstitial material, wherein, in the initial residual stress state, at least a portion of the interstitial material is depleted from the polycrystalline diamond volume to a first depth from a surface region of the polycrystalline diamond volume;
modeling a second residual stress state within the polycrystalline diamond volume of the cutting element, wherein, in the second residual stress state, at least a portion of the interstitial material is depleted from the polycrystalline diamond volume to a second depth from the surface region of the polycrystalline diamond volume;
wherein each of the first residual stress state and the second residual stress state at least partially results from the depletion of the interstitial material.

12. The method of claim 11, further comprising determining an optimal residual stress state within the polycrystalline diamond volume of the cutting element, wherein the optimal residual stress state is substantially optimal for cutting a selected formation type.

13. The method of claim 12, further comprising modeling depletion of the at least a portion of an interstitial material from the polycrystalline diamond volume of the cutting element such that the cutting element substantially comprises the optimal residual stress state within the polycrystalline diamond volume.

14. The method of claim 11, wherein modeling at least one of the initial residual stress state and the second residual stress state within the polycrystalline diamond volume of the cutting element further includes determining at least one of:
tensile stress within the polycrystalline diamond volume;
compressive stress within the polycrystalline diamond volume;
shear stress within the polycrystalline diamond volume.

15. The method of claim 11, further comprising:
modeling an initial thermal stability of the polycrystalline diamond volume of the cutting element, the polycrystalline diamond volume including the first region that includes an interstitial material;
modeling a second thermal stability of the polycrystalline diamond volume of the cutting element, wherein at least a portion of the interstitial material is depleted from the first region of the polycrystalline diamond volume.

16. The method of claim 11, wherein modeling at least one of the initial residual stress state and the second residual stress state of the polycrystalline diamond volume of the cutting element comprises obtaining a measurement of at least one characteristic of the cutting element.

17. The method of claim 16, wherein the at least one characteristic comprises at least one of:
thermal stability;
tensile stress;
compressive stress;
shear stress.

18. The method of claim 11, further comprising modeling the residual stress state within the polycrystalline diamond volume of the cutting element as a function of leach depth.

19. A method of manufacturing a cutting element optimized for cutting a particular formation type, the method comprising:
obtaining a measurement of at least one characteristic of a cutting element design at each of a plurality of leach depths, wherein the cutting element design comprises a polycrystalline diamond table and the plurality of leach depths comprise depths to which the polycrystalline diamond table is substantially depleted of interstitial material;
determining an optimal leach depth for the cutting element design, wherein the optimal leach depth comprises a leach depth at which a magnitude of the at least one characteristic of the cutting element design is substantially optimal for cutting a selected formation type;
leaching a cutting element such that a polycrystalline diamond table of the cutting element is substantially depleted of interstitial material to the optimal leach depth.

20. The method of claim 19, further comprising modeling at least one residual stress state within the polycrystalline diamond volume of the cutting element design using the measurement of the at least one characteristic of the cutting element design.

21. The method of claim 11, wherein:
the residual stress comprises one or more stresses that are developed within the cutting element during formation of the cutting element,
at least a portion of the one or more stresses remains within the cutting element following formation of the cutting element.

22. (canceled)

23. The method of claim 11, further comprising modeling a plurality of residual stress states within the polycrystalline diamond volume of the cutting element, wherein a different amount of the interstitial material is depleted from the first region of the polycrystalline diamond volume in conjunction with each of the plurality of modeled residual stress states.

24. The method of claim 11, wherein
the polycrystalline diamond volume includes a superabrasive face, a superabrasive side surface, and a chamfer extending between the superabrasive face and the superabrasive side surface;
the interstitial material is depleted from a portion of the polycrystalline volume that extends along at least a portion of each of the superabrasive face, the superabrasive side surface, and the chamfer.

25. The method of claim 11, wherein the initial residual stress state and the second residual stress state are each modeled under conditions in which the cutting element is used during drilling.

26. The method of claim 11, wherein the initial residual stress state and the second residual stress state are each modeled under conditions in which a greater amount of heat is generated at a surface portion of the polycrystalline diamond volume than at a location within the polycrystalline diamond volume.

27. The method of claim 26, wherein the greater amount of heat generated at a the surface portion of the polycrystalline diamond volume is modeled as frictional heat generated during drilling of a formation.

28. The method of claim 11, wherein the initial residual stress state is correlated to a first range of rock formation specific energies and the second residual stress state is correlated to a second range of rock formation specific energies.
